(19) United States
(12) Patent Application Publication
(10) Pub. No.: US 2012/0085364 A1
(43) Pub. Date: Apr. 12, 2012

(54) METHOD FOR MAKING UP EYELASHES

(75) Inventors: Gerard Malle, Villiers S/Morin (FR); Stephane Arditty, Ballainvilliers (FR); Nathalie Jager Lezer, Verrieres-Le-Buisson (FR)

(73) Assignee: L'OREAL, Paris (FR)

(21) Appl. No.: 13/263,381

(22) PCT Filed: Apr. 2, 2010
(86) PCT No.: PCT/FR2010/050644

§ 371 Date: Dec. 8, 2011

Related U.S. Application Data
(60) Provisional application No. 61/169,324, filed on Apr. 15, 2009.

(30) Foreign Application Priority Data
Apr. 7, 2009 (FR) 0952254

(51) Int. Cl. A45D 7/04; A45D 44/00; A61Q 1/10; A45D 7/00

(52) U.S. Cl. 132/207; 132/210; 132/288

(57) ABSTRACT

One subject of the invention is a method for making up eyelashes, consisting in:
a) coating the eyelashes with a deposit of at least one composition comprising, in a physiologically acceptable medium, at least one compound enabling the composition to attain, in the at least partially dry state, a modulus of rigidity Gp greater than or equal to 1 GPa,
b) in the presence of a stimulus to which said compound is sensitive, placing a shaping tool in contact with the thus coated eyelashes so as to modify the curvature of the eyelashes, said contact being maintained until the modulus of rigidity Gp of the composition is at least equal to 1 GPa, the stimulus being chosen so that the modulus of rigidity of at least 1 GPa is obtained in a time t that is less than the time t₀ that would be needed to obtain it by leaving the deposit to dry at room temperature.

The present invention relates to a method for making up eyelashes, consisting in:
a) coating the eyelashes with a deposit of at least one composition comprising, in a physiologically acceptable medium, at least one compound enabling the composition to attain, in the at least partially dry state, a modulus of rigidity Gp greater than or equal to 1 GPa,
b) in the presence of a stimulus to which said compound is sensitive, placing a shaping tool in contact with the thus coated eyelashes so as to modify the curvature of the eyelashes, said contact being maintained until the modulus of rigidity Gp of the composition is at least equal to 1 GPa, the stimulus being chosen so that the modulus of rigidity of at least 1 GPa is obtained in a time t that is less than the time t₀ that would be needed to obtain it by leaving the deposit to dry at room temperature.

The makeup method according to the invention is intended for eyelashes. The compositions may be makeup compositions, makeup bases, compositions to be applied over makeup, also referred to as top coats, or else compositions for the cosmetic treatment of the eyelashes. More especially, the invention relates to a mascara.

Compositions for making up the eyelashes, referred to as mascara, generally comprise, as is known, at least one wax and at least one film-forming polymer for depositing a film of makeup on the eyelashes and sheathing the latter, as described for example by document WO-A-95/15741. Users expect good cosmetic properties for these products, such as adhesion to the eyelashes, a lengthening or a curling of the eyelashes, a volumizing effect or a good separation of the eyelashes, or else a good wear property of the mascara over time, in particular a good resistance to rubbing, for example with the fingers or with fabric (handkerchiefs, towels). However, the mascara compositions do not always make it possible to obtain a remanent shaping of the eyelashes.

The objective of the present invention is to have a composition for making up eyelashes, which is applied easily and that imparts a remanent shaping of the eyelashes, especially from the curling point of view.

It was discovered that such a composition could be obtained by using a combination of specific compounds with a stimulus chosen from the light sources and heat sources.

The composition according to the invention is applied easily and adheres well to the eyelashes. It is observed that the shaping of the eyelashes is obtained rapidly and easily after application to the eyelashes, and that this shaping is long-lasting over time (a remanent effect). The makeup is comfortable for the user.

The expression “a remanent shaping of the eyelashes” is understood to mean that the shaping of the eyelashes is long-lasting over time, namely at least 6 h, preferably at least 10 h, preferably at least 24 h after application. The eyelashes therefore retain the shape that was imparted to them during application for this minimum time.

More specifically, one subject of the invention is a method for making up eyelashes, consisting in:

a) coating the eyelashes with a deposit of at least one composition comprising, in a physiologically acceptable medium, at least one compound enabling the composition to attain, in the at least partially dry state, a modulus of rigidity Gp greater than or equal to 1 GPa,
b) in the presence of a stimulus to which said compound is sensitive, placing a shaping tool in contact with the thus coated eyelashes so as to modify the curvature of the eyelashes, said contact being maintained until the plateau modulus of rigidity Gp of the composition is at least equal to 1 GPa, the stimulus being chosen so that the modulus of rigidity of at least 1 GPa is obtained in a time t that is less than the time t₀ that would be needed to obtain it by leaving the deposit to dry at room temperature.

Preferably, in the method according to the invention, the time t is at least 20% less and preferably at least 40% less than the time t₀.

Preferably, in the method according to the invention, the plateau modulus of rigidity Gp of said deposit, once attained, does not drop below 1 GPa when it is brought into contact with water or sebum.

The composition used in step a) of the method according to the invention comprises at least one compound enabling the composition to attain, in the at least partially dry state, a plateau modulus of rigidity Gp greater than or equal to 1 GPa.

This modulus of rigidity may be measured according to the following method:

The composition according to the invention is characterized by its viscoelastic behaviour, in particular with the aid of at least one rheological parameter.

In general, a material is said to be viscoelastic when, under the effect of shear, it has both the characteristics of a purely elastic material, i.e. capable of storing energy, and the characteristics of a purely viscous material, i.e. capable of dissipating energy.

More particularly, the viscoelastic behaviour of the compositions in accordance with the invention may be characterized by its modulus of rigidity G, its elasticity δ and its yield point τ_{c}. These parameters are defined in particular in the publication “Initiation á la rhéologie [Introduction to Rheology]”, G. Couarraze and J. L. Grossiord, 2nd edition, 1991, published by Lavoisier-Tec 1 Doc.

These parameters are determined by means of measurements performed at 25° C. ±0.5° C. using a Haake RheoStress 600® controlled-stress rheometer from the company THERMORHEO, equipped with a stainless-steel spindle with plate/plate geometry, the plate having a diameter of 20 mm and a gap (distance between the lower plate—known as the stator plate—on which the composition is deposited, and the upper plate—known as the rotor plate) of 0.3 mm. The two plates are striated in order to limit any slippage at the walls of the plates.

The dynamic measurements are carried out by applying a harmonic variation of the stress. In these experiments, the amplitudes of the shear, the shear rate and the stress are low so as to remain within the limits of the linear viscoelastic range of the material (the conditions enabling the rheological characteristics of the composition to be evaluated at rest).

The linear viscoelastic range is generally defined by the fact that the response of the material (i.e. the strain) is at any moment directly proportional to the value of the applied force (i.e. the stress). In this range, the applied stresses are low and the material is subjected to strains without its microscopic structure being modified. Under these conditions, the material is studied “at rest” and non-destructively.

The composition is subjected to a harmonic shear according to a stress τ(t) that varies sinusoidally according to an angular frequency ω (ω=2πv, v being the frequency of the applied shear). The composition thus sheared is subjected to a stress τ(t) and responds according to a strain γ(t) corresponding to microstrains for which the modulus of rigidity varies little as a function of the stress imposed.

The stress τ(t) and the strain γ(t) are defined respectively by the following equations:

τ(t)=τ₀ cos(ω·t) γ(t)=γ₀ cos(ω·t−δ)

τ₀ being the maximum amplitude of the stress and γ₀ being the maximum amplitude of the strain. δ is the phase angle between the stress and the strain.

The measurements are performed at a frequency of 1 Hz (ν=1 Hz).

The variation of the modulus of rigidity G (corresponding to the ratio of τ₀ over γ₀) and of the elasticity δ (corresponding to the phase angle of the applied stress relative to the measured strain) are thus measured as a function of the applied stress τ(t).

In particular, the strain of the composition is measured for the stress region in which the variation in the modulus of rigidity G and in the elasticity δ is less than 7% (microstrain region) and the “plateau” parameters Gp and δₚ are thus determined. The yield stress τ_{c} (corresponding to the minimum force that it is necessary to apply to the composition to cause it to flow) is determined from the curve δ=f(τ) and corresponds to the value of τ for which δ(τ_{c})=1.05 δₚ.

The compound enabling the composition to attain, in the at least partially dry state, a plateau modulus of rigidity Gp greater than or equal to 1 GPa may be chosen from:
compounds capable of polymerizing or crosslinking under the action of UV radiation (photopolymerization), in particular in the presence of water and a reactive powder,
compounds capable of polymerizing or crosslinking under the action of a chemical reaction of hydrosilylation type,
compounds capable of polymerizing or crosslinking ionically.

Preferably, this compound is chosen from photopolymerizable ionomers, silicone compounds that react via condensation or via hydrosilylation and compounds based on alginic acid.

Another subject of the invention is therefore a method for making up eyelashes, consisting in:

a) coating the eyelashes with a deposit of at least one composition comprising, in a physiologically acceptable medium, at least one compound chosen from photopolymerizable ionomers, silicone compounds that react via condensation or via hydrosilylation and compounds based on alginic acid,
b) in the presence of a stimulus to which said compound is sensitive, it being possible for the stimulus to be either UV or visible light radition, or a heat source, placing a shaping tool in contact with the thus coated eyelashes so as to modify the curvature of the eyelashes, said contact being maintained until a curling of the eyelashes is obtained.

The term “physiologically acceptable medium” means a medium that is compatible with keratin materials such as human skin.

The method according to the invention comprises a step of curling the eyelashes (i.e. contacting the eyelashes with a shaping tool so as to modify the curvature of the eyelashes).

This curling step may be carried out manually with the aid of any applicator that can be used on keratin fibres. In particular, this applicator may or may not be equipped with elements for separating and/or smoothing keratin fibres. Such elements are in particular bristies or teeth. The applicator may thus correspond to a brush equipped with bristles or teeth or to a comb. It may also correspond to any applicator described hereinbelow, and preferably to an eyelash curler.

Another subject of the invention is a kit for making up eyelashes, comprising the compound enabling the composition to attain, in the at least partially dry state, a plateau modulus of rigidity Gp greater than or equal to 1 GPa defined above, and also a source of stimulus and a shaping tool.

### Photopolymerization

The method for making up eyelashes according to the invention comprises, according to a first alternative, the following steps:
a) coating the eyelashes with a first composition and with a second composition, the first composition comprising at least one photopolymerizable ionomer, and the second composition comprising at least one reactive powder, the first and/or second composition comprising water, in order to form a deposit on the eyelashes, and
b) simultaneously and/or subsequently to step a), placing a shaping tool in contact with the thus coated eyelashes so as to modify the curvature of the eyelashes, and exposing the deposit obtained to radiation of suitable wavelength for a sufficient time to induce the crosslinking of said deposit.

According to one alternative, the first and second compositions are mixed before application to the keratin fibres, in particular the eyelashes.

According to a second alternative, the first and second compositions are mixed in situ at the time of application to the keratin fibres, in particular the eyelashes.

Another subject of the invention is a kit for coating keratin fibres, and in particular for making up eyelashes, comprising:
a first composition comprising at least one photopolymerizable ionomer;
a second composition comprising at least one reactive powder; and
a light source,
   the first and/or second composition comprising at least water, and
   the first and/or second composition comprising at least one additive chosen from pigments, waxes, fillers, thickeners, surfactants, film-forming polymers, and oils.

### Photopolymerizable Ionomers

These photopolymerizable ionomers are preferably chosen from the compounds of formula (I) below:

BXₘYₙ (I)

in which B represents an organic backbone,
X independently represents an ionic group capable of initiating a polymerization reaction in the presence of water and reactive powder,
Y independently represents a photopolymerizable group,
m is an integer greater than or equal to 2, and
n is an integer greater than or equal to 1.

Preferably, B is an oligomeric or polymeric organic backbone comprising carbon-carbon bonds, optionally comprising non-interfering substituents, such as oxygen, nitrogen or sulphur heteroatoms. The term “non-interfering” is understood to mean substituents or linkers that do not interfere unduly either with the photopolymerization reaction of the ionomer, or with the reaction, in the dark, of the ionomer with the reactive powder.

Preferably, the X group are acid groups, preferably carboxyl groups. Among the Y groups, mention may be made of polymerizable ethylenic unsaturated groups and polymerizable epoxy groups. Ethylenic unsaturated groups are preferred, preferably those that can be polymerized by a radical reaction mechanism; examples are in particular acrylates, methacrylates, alkenes and acrylamides, whether they are substituted or unsubstituted.

In aqueous systems, the polymerizable groups that are polymerized by a cationic mechanism, such as for example polymerizable ethylenic unsaturated groups, for instance vinyl ether groups, and polymerizable epoxy groups, are less preferred since a radical mechanism is easier to use than a cationic mechanism in such systems.

The X and Y groups may be connected to the backbone B directly or by means of a non-interfering organic group, such as alkyl, alkoxyalkyl, aryl, aryloxyalkyl, alkoxyaryl, aralkyl, or alkaryl groups, which are substituted or unsubstituted.

The photopolymerizable ionomers of formula (I) may be prepared according to several synthesis pathways. The preferred synthesis pathway is the following: reaction between n X groups of a polymer of formula B(X)ₘ₊ₙ and a compound suitable for forming n pendant Y groups.

The suitable compound, also referred to as the “coupler compound”, comprises both a Y group and a reactive group capable of reacting with the polymer, by virtue of the X group, in order to form a covalent bond between the coupler compound and the X group, by connecting the Y group to the backbone B as a pendant chain. The preferred coupler compounds are organic compounds, optionally comprising non-interfering substituents and/or non-interfering linkers between the Y group and the reactive group.

Preferred photopolymerizable ionomers of formula (I) are those for which each X is a carboxyl group, and each Y is an ethylenic unsaturated group that can be polymerized by a radical reaction.

Such ionomers are conventionally prepared by reaction between a polyalkenoid acid (i.e. a polymer of formula B(X)ₘ₊ₙ where each X is a carboxyl group), and a coupler compound comprising both an ethylenic unsaturated group and a group capable of reacting with a carboxylic acid group. The molecular weight of the photopolymerizable ionomers is preferably between 250 and 500 000, preferably between 5 000 and 100 000. These ionomers are generally soluble in water, but less soluble than the polyalkenoid acids from which they derive.

The preferred polyalkenoid acids are those prepared by homopolymerization and copolymerization of unsaturated aliphatic carboxylic acids, for example acrylic acid, 2-chloroacrylic acid, 3-chloroacrylic acid, 2-bromoacrylic acid, 3-bromoacrylic acid, methacrylic acid, itaconic acid, maleic acid, glutaconic acid, aconitic acid, citraconic acid, mesaconic acid, fumaric acid and tiglic acid. Monomers that can be copolymerized with the unsaturated aliphatic carboxylic acids include unsaturated aliphatic compounds such as styrene, butadiene, acrylamide, acrylonitrile, methacrylonitrile, vinyl chloride, allyl chloride, vinyl acetate, and the esters of acrylic and methacrylic acids such as methyl acrylate, ethyl acrylate, propyl acrylate, isopropyl acrylate, n-butyl acrylate, isobutyl acrylate, 2-ethylhexyl acrylate, methyl methacrylate, ethyl methacrylate, n-butyl methacrylate, isobutyl methacrylate and 2-hydroxyethyl methacrylate.

Preferably, homopolymers and copolymers of acrylic acid are used.

The polyalkenoid acid should be cosmetically acceptable, i.e. free of unpolymerized monomers.

Other preferred polyalkenoid acids are the homopolymers of polyacrylic acid, and the copolymers of acrylic and itaconic acids, of acrylic and maleic acids, of methyl vinyl ether and maleic anhydride or acid, of ethylene and maleic anhydride or acid, and of styrene and maleic anhydride or acid.

The polymers of formula B(X)ₘ₊ₙ may be prepared for example by free-radical polymerization, i.e. in solution, in emulsion or interfacially. Such polymers may react with coupler compounds in the presence of suitable catalysts.

Use may especially be made, as coupler compounds, of compounds containing at least one group capable of reacting with X to form a covalent bond, and also at least one polymerizable ethylenic unsaturated group. When X is a carboxyl group, the group capable of reacting with X may be chosen from: —OH, —NH₂, —NCO, —COCl, and

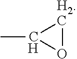

Examples of coupler compounds are preferably the corresponding methacrylates and acrylates below:

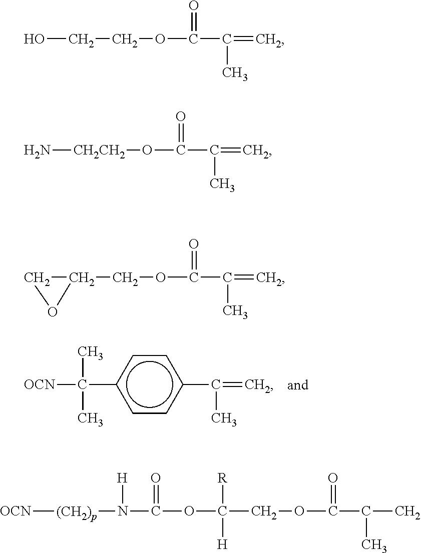

where p is between 1 and 20, and R is a hydrogen or an alkyl group having from 1 to 6 carbon atoms,
and also the allyl of the following formula:

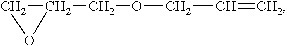

Preferred coupler compounds are the corresponding methacrylates and acrylates below, with R as described above:

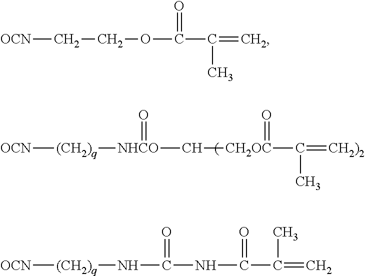

where q is between 1 and 18.

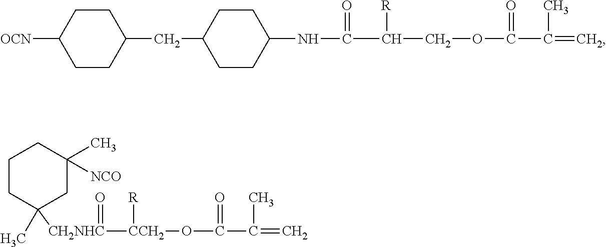

The preferred ionomers of formula (I) are those prepared by the reaction between a polymer of formula B(X)ₘ₊ₙ where each X is a —COON group, and a coupler compound comprising a reactive group of formula —NCO.

The photopolymerizable ionomers described above generally represent from 10 to 70% by weight, and preferably from 20 to 50% by weight, of the first composition of the present invention.

### Reactive Powder

The reactive powder comprises at least one reactive compound chosen from metal oxides, such as zinc oxide or magnesium oxide, and ion-releasing glasses.

Preferably, the reactive powder comprises releasable fluorine. Preferably, the reactive powder is chosen from ion-releasing glasses, preferably from fluoroaluminosilicates and fluoroaluminoborates.

Furthermore, the reactive powder may also comprise, besides the reactive compound, at least one polymerization initiator. Such a polymerization initiator may be chosen from photoinitiators, in particular the initiators for polymerization that is induced by UV radiation or visible light.

The photoinitiators that can be used in the cosmetic compositions of the present invention are also known in the art and are described, for example, in the following articles, the content of which forms an integral part of the present patent application: “Les photoinitiateurs dans la réticulation des revêtements [Photoinitiators in the crosslinking of coatings]”, G. Li Bassi, Double Liaison—Chimie des Peintures, No. 361, November 1985, pages 34-41; “Applications industrielles de la polymérisation photoinduite [Industrial applications of photo-induced polymerization]”, Henri Strub, L'Actualité Chimique, February 2000, pages 5-13; and “Photopolymères: considérations théoriques et réaction de prise [Photopolymers: theoretical considerations and setting reaction]”, Marc, J. M. Abadie, Double Liaison—Chimie des Peintures, No. 435-436, 1992, pages 28-34.

These photoinitiators encompass both radical and cationic photoinitiators:
the α-hydroxy ketones sold, for example, under the names Irgacure® 184, 1173, 2959, 149, 1000, 500 and 4265 by the company Ciba,
the α-amino ketones sold, for example, under the names Irgacure® 907 and 369 by the company Ciba,
the chloroacetophenones sold, for example, under the names Trigonal® P by the company Akzo and Sandoray® 1000 by the company Sandoz,
the diones such as camphorquinone and the aromatic ketones sold, for example, under the names Daitocure® by Dainippon, Uvecryl® P 36 by UCB, Esacure® TZT by Lamberti and Quantacure® ITX by Ward Blenkinsop. Mention may also be made of thioxanthones (for example Ultracure® DXT from Sherwin Williams) and quinones (for example 2-ethylanthraquinone from BASF). These diones, aromatic ketones and quinones usually require the presence of a hydrogen-donating compound such as tertiary amines and more particularly alkanolamines,
the benzoin ethers sold, for example, under the name Esacure® EB 3 by the company Lamberti and under the name Trigonal® 14 by Akzo,
the α-dicarbonyl derivatives, the most common representative of which is benzyl dimethyl ketal, sold under the name Irgacure® 651 by Ciba. Other commercial products are sold by the company Lamberti under the name Esacure® KBO and by the company Ward Blenkinsop under the name Quantacure® PDO,
the acylphosphine oxides such as, for example, the bis-acylphosphine oxides (BAPOs) sold, for example, under the names Irgacure® 819, 1700, 1800 and 1850 and Darocur® 4265 by the company Ciba,
the oxime esters such as, for example, Irgacure® OXE01 and OXE02 sold by the company Ciba,
the aryl onium salts such as the diaryliodonium or triarylsulphonium or ferrocenium salts. Preferably, use is made of diphenyliodonium salts, such as, for example, diphenyliodonium chloride, bromide, iodide or hexafluorophosphate.
The acyl germanium derivatives, such as, for example, bis-(4-methoxybenzoyl)diethylgermanium.

In one preferred embodiment of the invention, use is made of polymer photoinitiators or photoinitiators attached to a high molecular weight molecule. The choice of such a high weight photoinitiator has the advantage of a better safety of photocrosslinkable cosmetic compositions due to the absence of small, highly reactive molecules capable of diffusing to the neighbouring biological substrates. As for the copolymerizable components, the weight-average molecular weight of the photoinitiator is preferably at least equal to 500.

Mention may be made, by way of example, of the α-hydroxy ketone oligomer corresponding to the formula below:

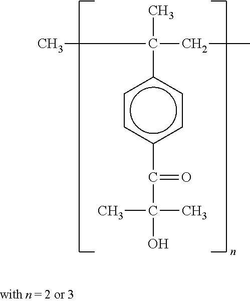

and that is sold under the names ESACURE® KIP 150 and ESACURE® KIP EM by the company LAMBERTI.

The polymer to which the photoinitiator group is attached may optionally comprise one or more ethylenic double bonds optionally enabling the integration, into the macromolecular network, of photoinitiator molecules that have not undergone photo-induced scission. Mention may be made, as examples of such high molecular weight photoinitiators bearing ethylenic double bonds, of those corresponding to the formulae below:

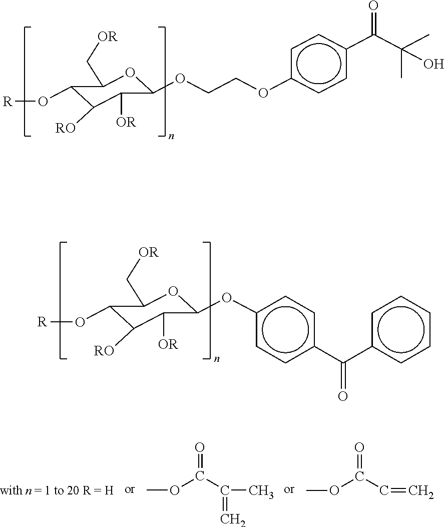

structures that are described in the following articles: S. Knaus, Pure Appl. Chem., A33(7), 869 (1996); S. Knaus, J. Polym. Sci., Part A=Polym. Chem., 33, 929 (1995); and R. Liska, Rad'Tech Europe 97, Lyon, F, 1997, Conference Proceedings.

In the cosmetic compositions of the present invention use is preferably made of a mixture of photoinitiators that absorb light at different wavelengths. It is thus possible to adapt the absorption spectrum of the photocrosslinkable cosmetic compositions to the emission spectrum of the light sources used.

The concentration of the photoinitiator(s) used depends on a large number of factors such as, for example, the reactivity of the various components of the mixture, the presence of pigments or dyes, the desired crosslinking density, the intensity of the light source or the exposure time.

To obtain satisfactory mechanical properties, a total amount of photoinitiator(s) at least equal to 0.01% by weight and at most equal to 5% by weight, and preferably between 0.1% and 5% by weight, relative to the total weight of compound comprising ethylenic double bonds, will generally be used.

Preferably, a photoinitiator that is a diphenyliodonium salt, preferably diphenyliodonium chloride, is used. Such a photoinitiator is present in particular in commercial compositions also comprising a reactive compound such as fluoroaluminosilicate glass, which are sold by 3M under the references Vitrebond 7512P and Vitrebond 7510.

Preferably, the powder (i.e. reactive powder or reactive powder+ionomer)/liquid weight ratio is between 1/1 and 5/1.

### Light Source

The light source according to the invention corresponds to a source of radiation. Such sources of radiation are chosen from sources of ultraviolet radiation or of visible light.

The radiation suitable for crosslinking the cosmetic compositions of the present invention has a wavelength between 10 nm and 500 μm, preferably between 400 and 700 nm, preferably between 400 and 520 nm. The use of lasers may also be envisaged.

In one preferred embodiment of the invention, use is made of a UV lamp and in particular a mercury-vapour lamp, the mercury optionally being doped with other elements, such as gallium, making it possible to modify the emission spectrum of the light source. The radiation suitable for crosslinking the cosmetic compositions of the present invention has a power between 500 and 2400 mW/cm², preferably between 700 and 850 mW/cm².

The exposure time of the deposited film to the radiation depends on various factors such as the chemical nature and the concentration of the reactive components or else the desired crosslinking density.

For the compositions according to the invention, it will generally be sought to obtain satisfactory results for an exposure time between 10 seconds and 10 minutes, preferably between 10 seconds and 1 minute, preferably between 15 and 40 seconds.

### Hydrophilic Solvent

The first and/or second composition comprises water.

When it comprises water, the first and/or second composition may also comprise at least one cosolvent.

The term “cosolvent” is understood to mean a compound that helps to dissolve the photocrosslinkable ionomer in water, in order to form a homogeneous aqueous solution of cosolvent and ionomer. Said cosolvent is chosen from water-miscible solvents (solvent/water mixture capable of forming, at 25° C., a mixture that is homogeneous and transparent to the eye) for instance lower monoalcohols having from 1 to 5 carbon atoms such as ethanol or isopropanol, diols such as glycols having from 2 to 8 carbon atoms for instance propylene glycol, ethylene glycol, 1,3-butylene glycol, dipropylene glycol, or else 1,3-propanediol or 1,a-butanediol, C₃-C₆ ketones such as acetone, methyl ethyl ketone or methyl isobutyl ketone, C₂-C₄ aldehydes, and mixtures thereof, but also from alkenyl hydrophilic copolymerizable solvents of low molecular weight, for instance 2-hydroxyethyl methacrylate or 2-hydroxypropyl methacrylate. The term “copolymerizable” is understood to mean that the cosolvent is capable of reacting in a compatible manner with the ionomer.

The water, and optionally the water-miscible organic solvent, may be present in a content ranging from 1% to 95%, preferably from 5% to 80%, and better still from 10% to 60%, by weight relative to the total weight of the first and/or second composition.

The compositions according to the invention may also comprise, besides the compounds mentioned above, pigments, oils, waxes, surfactants, film-forming polymers, fillers, thickeners, pulverulent compounds, or any other cosmetic additive.

### Compounds Capable of Polymerizing Under the Action of Chemical Crosslinking

Silicone Compounds that React via Hydrosilylation or via Condensation

The method for making up eyelashes according to the invention comprises, according to a second alternative, the following steps:
a) coating the eyelashes with a first composition and with a second composition, the first composition comprising at least one silicone compound X, and the second composition comprising at least one silicone compound Y, in order to form a deposit on the eyelashes, and
b) simultaneously and/or subsequently to step a), placing a shaping tool in contact with the thus coated eyelashes so as to modify the curvature of the eyelashes, for a sufficient time to induce the crosslinking of said deposit.

According to one alternative, the first and second compositions are mixed before application to the keratin fibres.

According to a second alternative, the first and second compositions are mixed in situ at the time of application to the keratin fibres.

### 1—Silicone Compounds X and Y Capable of Reacting via Hydrosilylation

According to one embodiment, compounds X and Y are capable of reacting via hydrosilylation, it being possible for this reaction to be represented schematically in simple terms as follows:

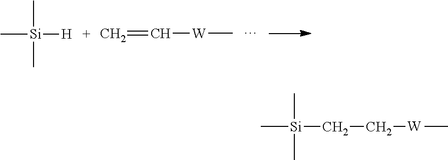

with W representing a carbon-based and/or silicone chain comprising one or more unsaturated aliphatic groups.

In this case, compound X may be chosen from silicone compounds comprising at least two unsaturated aliphatic groups. For example, compound X may comprise a silicone main chain whose unsaturated aliphatic groups are pendent on the main chain (side group) or located at the ends of the main chain of the compound (end group). In the rest of the description, these particular compounds will be referred to as polyorganosiloxanes containing unsaturated aliphatic groups.

According to one embodiment, compound X and/or compound Y bears at least one polar group, as described above, capable of forming at least one hydrogen bond with the eyelashes. This polar group is advantageously borne by compound X that comprises at least two unsaturated aliphatic groups.

According to one embodiment, compound X is chosen from polyorganosiloxanes comprising at least two unsaturated aliphatic groups, for example two or three vinyl or allylic groups, each bonded to a silicon atom.

According to one advantageous embodiment, compound X is chosen from polyorganosiloxanes comprising siloxane units of formula:

$${R}_{m} {R}^{′} {SiO}_{( \frac{3 - m}{2} )} \qquad ( I )$$

in which:
R represents a linear or cyclic monovalent hydrocarbon-based group containing from 1 to 30 carbon atoms, preferably from 1 to 20 and better still from 1 to 10 carbon atoms, for instance a short-chain alkyl radical containing, for example, from 1 to 10 carbon atoms, in particular a methyl radical, or alternatively a phenyl group, preferably a methyl radical,
m is equal to 1 or 2, and
R′ represents:
an unsaturated aliphatic hydrocarbon-based group containing from 2 to 10 and preferably from 2 to 5 carbon atoms, for instance a vinyl group or a group —R″—CH═CHR′″ in which R″ is a divalent aliphatic hydrocarbon-based chain containing from 1 to 8 carbon atoms, bonded to the silicon atom and R′″ is a hydrogen atom or an alkyl radical containing from 1 to 4 carbon atoms, preferably a hydrogen atom; groups R′ that may be mentioned include vinyl and allylic groups and mixtures thereof; or
an unsaturated cyclic hydrocarbon-based group containing from 5 to 8 carbon atoms, for instance a cyclohexenyl group.

Preferably, R′ is an unsaturated aliphatic hydrocarbon-based group, preferably a vinyl group.

According to one particular embodiment, the polyorganosiloxane also comprises units of formula:

$${R}_{n} {SiO}_{( \frac{4 - n}{2} )} \qquad ( II )$$

in which R is a group as defined above, and n is equal to 1, 2 or 3.

According to one variant, compound X may be a silicone resin comprising at least two ethylenically unsaturated groups, said resin being capable of reacting with compound Y via hydrosilylation. Examples that may be mentioned include resins of MQ or MT type themselves bearing —CH═CH₂ unsaturated reactive ends.

These resins are crosslinked organosiloxane polymers.

The nomenclature of silicone resins is known under the name “MDTQ”, the resin being described as a function of the various siloxane monomer units it comprises, each of the letters M, D, T and Q characterizing a type of unit.

The letter M represents the monofunctional unit of formula (CH₃)₃SiO_{1/2}, the silicon atom being bonded to only one oxygen atom in the polymer comprising this unit.

The letter D means a difunctional unit (CH₃)₂SiO_{2/2} in which the silicon atom is bonded to two oxygen atoms.

The letter T represents a trifunctional unit of formula (CH₃)SiO_{3/2}.

In the units M, D and T defined above, at least one of the methyl groups may be substituted with a group R other than the methyl group, such as a hydrocarbon-based radical (especially alkyl) containing from 2 to 10 carbon atoms or a phenyl group, or alternatively a hydroxyl group.

Finally, the letter Q means a tetrafunctional unit SiO_{4/2} in which the silicon atom is bonded to four hydrogen atoms, which are themselves bonded to the rest of the polymer. Examples of such resins that may be mentioned include MT silicone resins such as poly(phenylvinylsilsesquioxane), for instance the product sold under the reference SST-3PV1 by the company Gelest.

Preferably, the compounds X comprise from 0.01% to 1% by weight of unsaturated aliphatic groups.

Advantageously, compound X is chosen from polyorganopolysiloxanes, especially those comprising the siloxane units (I) and optionally (II) described above.

Compound Y preferably comprises at least two free Si—H groups (hydrosilane groups).

Compound Y may be chosen advantageously from organosiloxanes comprising at least one alkylhydrosiloxane unit having the following formula:

$${R}_{p} {HSio}_{( \frac{3 - p}{2} )} \qquad ( III )$$

in which:

R represents a linear or cyclic monovalent hydrocarbon-based group containing from 1 to 30 carbon atoms, for instance an alkyl radical containing from 1 to 30 carbon atoms, preferably from 1 to 20 and better still from 1 to 10 carbon atoms, in particular a methyl radical, or alternatively a phenyl group, and p is equal to 1 or 2. Preferably, R is a hydrocarbon-based group, preferably methyl.

These organosiloxane compounds Y containing alkylhydrosiloxane units may also comprise units of formula:

$${R}_{n} {SiO}_{( \frac{4 - n}{2} )} \qquad ( II )$$

as defined above.

Compound Y may be a silicone resin comprising at least one unit chosen from the units M, D, T and Q as defined above and comprising at least one Si—H group, such as the poly(methylhydridosilsesquioxanes) sold under the reference SST-3 MH1.1 by the company Gelest.

Preferably, these organosiloxane compounds Y comprise from 0.5% to 2.5% by weight of Si—H groups.

Advantageously, the radicals R represent a methyl group in the formulae (I), (II) and (III) above.

Preferably, these organosiloxanes Y comprise end groups of formula (CH₃)₃SiO_{1/2}.

Advantageously, the organosiloxanes Y comprise at least two alkylhydrosiloxane units of formula (H₃C)(H)SiO and optionally comprise (H₃C)₂SiO units.

Such organosiloxane compounds Y containing hydrosilane groups are described, for example, in document EP 0 465 744.

1a—Additional Reactive Compounds

According to one embodiment, the compositions comprising compound X and/or Y may also comprise an additional reactive compound such as:
organic or mineral particles comprising at their surface at least 2 unsaturated aliphatic groups: mention may be made, for example, of silicas surface-treated, for example, with silicone compounds containing vinyl groups, for instance cyclotetramethyltetravinylsiloxane-treated silica,
silazane compounds such as hexamethyldisilazane.
   1b—Catalyst

The hydrosilylation reaction is advantageously performed in the presence of a catalyst that may be present in one or the other of the compositions comprising compound X and/or compound Y or in a separate composition, the catalyst preferably being platinum-based or tin-based.

Examples that may be mentioned include platinum-based catalysts deposited on a support of silica gel or charcoal powder, platinum chloride, platinum salts and chloroplatinic acids.

Chloroplatinic acids in hexahydrate or anhydrous form, which are readily dispersible in organosilicone media, are preferably used.

Mention may also be made of platinum complexes such as those based on chloroplatinic acid hexahydrate and on divinyltetramethyldisiloxane.

The catalyst may be present in one or the other of the compositions that are of use in the present invention in a content ranging from 0.0001% to 20% by weight relative to the total weight of the composition comprising it.

Polymerization inhibitors or retarders, and more particularly catalyst inhibitors, may also be introduced into the compositions of the invention, in order to increase the stability of the composition over time or to retard the polymerization. Mention may be made, in a non-limiting manner, of cyclic polymethylvinylsiloxanes, and in particular tetravinyltetramethylcyclotetrasiloxane, and acetylenic alcohols, which are preferably volatile, such as methylisobutynol.

The presence of ionic salts such as sodium acetate, in one and/or the other of the first and second compositions, may have an influence on the rate of polymerization of the compounds.

By way of example of a combination of compounds X and Y that react via hydrosilylation, mention may be made of the following references sold by the company Dow Corning: DC 7-9800 Soft Skin Adhesive Parts A & B, and also the mixtures A and B below prepared by Dow Corning:

MIXTURE A:

| Ingredient (INCI Name) | CAS No. | Contents (%) | Function |
|---|---|---|---|
| Dimethyl Siloxane, | 68083-19-2 | 55-95 | Polymer |
| dimethylvinylsiloxy-terminated | | | |
| Silica Silylate | 68909-20-6 | 10-40 | Filler |
| 1,3-Diethenyl-1,1,3,3- | 68478-92-2 | Trace | Catalyst |
| Tetramethyldisiloxane | | | |
| complexes | | | |
| Tetramethyldivinyldisiloxane | 2627-95-4 | 0.1-1 | Polymer |

MIXTURE B:

| Ingredient (INCI Name) | CAS No. | Contents (%) | Function |
|---|---|---|---|
| Dimethyl Siloxane, | 68083-19-2 | 55-95 | Polymer |
| dimethylvinylsiloxy-terminated | | | |
| Silica Silylate | 68909-20-6 | 10-40 | Filler |
| Dimethyl, Methylhydrogen | 68037-59-2 | 1-10 | Polymer |
| Siloxane, trimethylsiloxy- | | | |
| terminated | | | |

Advantageously, compounds X and Y are chosen from silicone compounds capable of reacting via hydrosilylation; in particular, compound X is chosen from polyorganosiloxanes comprising units of formula (I) described above and compound Y is chosen from or ganosiloxanes comprising alkylhydrosiloxane units of formula (III) described above. According to one particular embodiment, compound X is a polydimethylsiloxane containing vinyl end groups and compound Y is a methylhydrosiloxane.

### Compounds X and Y Capable of Reacting via Condensation

According to this embodiment, compounds X and Y are capable of reacting via condensation, either in the presence of water (hydrolysis) by reaction of 2 compounds bearing alkoxysilane groups, or via “direct” condensation by reaction of a compound bearing alkoxysilane group(s) and a compound bearing silanol group(s) or by reaction of 2 compounds bearing silanol group(s).

When the condensation is performed in the presence of water, this water may in particular be ambient moisture, residual water of the eyelashes, or the water provided by an external source, for example premoistening of the eyelashes (for example with a mister, or natural or artificial tears).

In this mode of reaction via condensation, compounds X and Y, which may be identical or different, may thus be chosen from silicone compounds whose main chain comprises at least two alkoxysilane groups and/or at least two silanol (Si—OH) groups, on the side and/or at the end of the chain.

According to one embodiment, compound X and/or compound Y bears at least one polar group, as described above, capable of forming at least one hydrogen bond with the eyelashes.

In one advantageous embodiment, compounds X and/or Y are chosen from polyorganosiloxanes comprising at least two alkoxysilane groups. The term “alkoxysilane group” means a group comprising at least one —Si—OR portion, R being an alkyl group containing from 1 to 6 carbon atoms.

Compounds X and Y are especially chosen from polyorganosiloxanes comprising alkoxysilane end groups, more specifically those comprising at least 2 alkoxysilane end groups and preferably trialkoxysilane end groups.

These compounds X and/or Y preferably predominantly comprise units of formula:

R⁹ₛSiO_{(4-s)/2}, (IV)

in which R⁹ independently represents a radical chosen from alkyl groups containing from 1 to 6 carbon atoms, phenyl and fluoroalkyl groups, and S is equal to 0, 1, 2 or 3. Preferably, R⁹ independently represents an alkyl group having from 1 to 6 carbon atoms. Alkyl groups that may especially be mentioned include methyl, propyl, butyl, and hexyl, and mixtures thereof, preferably methyl or ethyl. A fluoroalkyl group that may be mentioned is 3,3,3-trifluoropropyl.

According to one particular embodiment, compounds X and Y, which may be identical or different, are polyorganosiloxanes comprising units of formula:

(R⁹₂SiO₂)_{f}— (V)

in which R⁹ is as described above, preferably R⁹ is a methyl radical, and f is in particular such that the polymer has a viscosity at 25° C. ranging from 0.5 to 3000 Pa·s and preferably ranging from 5 to 150 Pa·s, for example f may range from 2 to 5000, preferably from 3 to 3000 and better still from 5 to 1000.

These polyorganosiloxane compounds X and Y comprise at least 2 trialkoxysilane end groups per polymer molecule, said groups having the following formula:

—ZSiR¹ₓ(OR)₃₋ₓ, (VI)

in which:

the radicals R independently represent a methyl, ethyl, n-propyl, isopropyl, n-butyl, sec-butyl or isobutyl group, preferably a methyl or ethyl group,

R¹ is a methyl or ethyl group,

x is equal to 0 or 1 and preferably x is equal to 0, and

Z is chosen from: divalent hydrocarbon-based groups not comprising any ethylenically unsaturated groups and containing from 1 to 18 carbon atoms, preferably from 2 to 18 carbon atoms (alkylene groups), combinations of divalent hydrocarbon-based radicals and of siloxane segments of formula (IX) below:

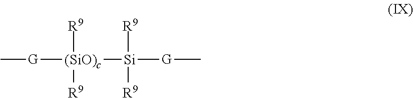

R⁹ being as described above, G is a divalent hydrocarbon-based radical not comprising any ethylenically unsaturated groups and containing from 1 to 18 carbon atoms, preferably from 2 to 18 carbon atoms and c is an integer ranging from 1 to 6.

Z and G may be chosen especially from alkylene groups such as methylene, ethylene, propylene, butylene, pentylene and hexylene, and arylene groups such as phenylene. Preferably, Z is an alkylene group, and better still ethylene.

These polymers may contain on average at least 1.2 trialkoxysilane end groups or end chains per molecule, and preferably on average at least 1.5 trialkoxysilane end groups per molecule. Since these polymers may contain at least 1.2 trialkoxysilane end groups per molecule, some may comprise other types of end groups such as end groups of formula CH₂═CH—SiR⁹₂— or of formula R⁶₃—Si—, in which R⁹ is as defined above and each R⁶ group is independently chosen from R⁹ or vinyl groups. Examples of such end groups that may be mentioned include trimethoxysilane, triethoxysilane, vinyldimethoxysilane and vinylmethyloxyphenylsilane groups.

Such polymers are especially described in documents U.S. Pat. No. 3,175,993, U.S. Pat. No. 4,772,675, U.S. Pat. No. 4,871,827, U.S. Pat. No. 4,888,380, U.S. Pat. No. 4,898,910, U.S. Pat. No. 4,906,719 and U.S. Pat. No. 4,962,174, the content of which is incorporated into the present patent application by reference.

As compound X and/or Y, mention may be made in particular of the polymer of formula

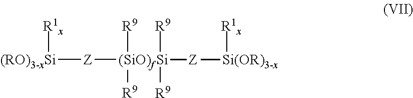

in which R, R¹, R⁹, Z, x and f are as described above.

Compounds X and/or Y may also comprise a mixture of polymers of formula (VII) above with polymers of formula (VIII) below:

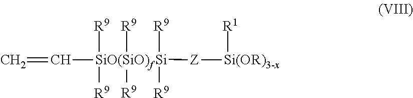

in which R, R¹, R⁹, Z, x and f are as described above.

When the polyorganosiloxane compound X and/or Y containing alkoxysilane group(s) comprises such a mixture, the various polyorganosiloxanes are present in contents such that the organosilyl end chains represent less than 40% and preferably less than 25%, by number, of the end chains.

The polyorganosiloxane compounds X and/or Y that are particularly preferred are those of formula (VII) described above. Such compounds X and/or Y are described, for example, in document WO 01/96450.

According to one preferred embodiment, the compounds X and Y represent a mixture of polydimethylsiloxanes containing methoxysilane groups.

As indicated above, compounds X and Y may be identical or different.

According to one variant, one of the two reactive compounds X or Y is of silicone nature and the other is of organic nature. For example, compound X is chosen from organic oligomers or polymers or organic/silicone hybrid oligomers or polymers, said polymers or oligomers comprising at least two alkoxysilane groups, and Y is chosen from silicone compounds such as the polyorganosiloxanes described above. In particular, the organic oligomers or polymers are chosen from vinyl, (meth)acrylic, polyester, polyamide, polyurethane and/or polyurea, polyether, polyolefin or perfluoropolyether oligomers or polymers, and hyperbranched organic dendrimers and polymers, and mixtures thereof.

According to one embodiment, compound X of organic nature or of organic/silicone hybrid nature bears at least one polar group, as described above, capable of forming at least one hydrogen bond with the eyelashes.

The organic polymers of vinyl or (meth)acrylic nature bearing alkoxysilane side groups may in particular be obtained via copolymerization of at least one organic vinyl or (meth)acrylic monomer with a (meth)acryloxypropyltrimethoxysilane, a vinyltrimethoxysilane, a vinyltriethoxysilane, an allyltrimethoxysilane, etc.

Examples that may be mentioned include the (meth)acrylic polymers described in the document by Kusabe, M., Pitture e Verniei—European Coating; 12-B, pages 43-49, 2005, and especially the polyacrylates containing alkoxysilane groups referenced as MAX from Kaneka or those described in the publication by Probster, M., Adhesion-Kleben & Dichten, 2004, 481 (1-2), pages 12-14.

The organic polymers resulting from a polycondensation or a polyaddition, such as polyesters, polyamides, polyurethanes and/or polyureas, and polyethers, and bearing alkoxysilane side and/or end groups, may result, for example, from the reaction of an oligomeric prepolymer as described above with one of the following silane coreagents bearing at least one alkoxysilane group: aminopropyltrimethoxysilane, aminopropyltriethoxysilane, aminoethylaminopropyltrimethoxysilane, glycidoxypropyltrimethoxysilane, glycidoxypropyltriethoxysilane, epoxycyclohexylethyltrimethoxysilane, mercaptopropyltrimethoxysilane.

Examples of polyethers and polyisobutylenes containing alkoxysilane groups are described in the publication by Kusabe, M., Pitture e Verniei—European Coating; 12-B, pages 43-49, 2005. As examples of polyurethanes containing alkoxysilane end groups, mention may be made of those described in the document by Probster, M., Adhesion-Kleben & Dichten, 2004, 481 (1-2) pages 12-14 or else those described in the document by Landon, S., Pitture e Verniei vol. 73, No. 11, pages 18-24, 1997 or in the document by Huang, Mowo, Pitture e Verniei vol. 5, 2000, pages 61-67; mention may be made especially of the polyurethanes containing alkoxysilane groups from OSI-WITCO-GE.

Polyorganosiloxane compounds X and/or Y that may be mentioned include resins of MQ or MT type themselves bearing alkoxysilane and/or silanol ends, for instance the poly(isobutylsilsesquioxane) resins functionalized with silanol groups sold under the reference SST-S7C41 (3 Si—OH groups) by the company Gelest.

2a—Additional Reactive Compound

One of the compositions that are of use in the present invention may also comprise an additional reactive compound comprising at least two alkoxysilane or silanol groups.

Mention may be made, for example, of the organic or mineral particles comprising at their surface alkoxysilane and/or silanol groups, for instance fillers surface-treated with such groups.

2b—Catalyst

The condensation reaction may be performed in the presence of a metal-based catalyst that may be present in one or the other of the compositions comprising X and/or Y or in a separate composition. The catalyst that is of use in this type of reaction is preferably a titanium-based catalyst.

Mention may be made especially of the tetraalkoxytitanium-based catalysts of formula

Ti(OR²)_{y}(OR³)_{4-y},

in which R² is chosen from tertiary alkyl radicals such as tert-butyl, tert-amyl and 2,4-dimethyl-3-pentyl; R³ represents an alkyl radical containing from 1 to 6 carbon atoms, preferably a methyl, ethyl, n-propyl, isopropyl, n-butyl, sec-butyl or hexyl group and y is a number ranging from 3 to 4 and better still from 3.4 to 4.

The catalyst may be present in one or the other of the compositions that are of use in the present invention in a content ranging from 0.0001% to 20% by weight relative to the total weight of the composition(s) containing it.

2c—Diluent

The compositions of use comprising X and/or Y may also comprise a volatile silicone oil (or diluent) for reducing the viscosity of the composition. This oil may be chosen from short-chain linear silicones such as hexamethyldisiloxane or octamethyltrisiloxane, and cyclic silicones such as octamethylcyclotetrasiloxane and decamethylcyclopentasiloxane, and mixtures thereof.

This silicone oil may represent from 5% to 95% and preferably from 10% to 80% by weight relative to the weight of each composition.

As examples of a combination of compounds X and Y bearing alkoxysilane groups and reacting via condensation, mention may be made of the combination of mixtures A′ and B′ below prepared by the company Dow Corning:

Mixture A′:

| Ingredient (INCI Name) | CAS No. | Contents (%) | Function |
|---|---|---|---|
| Bis-Trimethoxysiloxyethyl | PMN87176 | 25-45 | Polymer |
| Tetramethyldisiloxyethyl | | | |
| Dimethicone (1) | | | |
| Silica silylate | 68909-20-6 | 5-20 | Filler |
| Disiloxane | 107-46-0 | 30-70 | Solvent |

Mixture B′:

| Ingredient (INCI Name) | CAS No. | Contents (%) | Function |
|---|---|---|---|
| Disiloxane | 107-46-0 | 80-99 | Solvent |
| Tetra-T-Butyl Titanate | — | 1-20 | Catalyst |

It should furthermore be noted that the identical compounds X and Y are combined in mixture A′.

### Compounds Capable of Polymerizing Under the Action of Ionic Crosslinking

The method for making up eyelashes according to the invention comprises, according to a third alternative, the following steps:
a) coating the eyelashes with a first composition and with a second composition, the first composition comprising at least one compound based on alginic acid, and the second composition comprising at least one complexing agent, in order to form a deposit on the eyelashes, and
b) simultaneously and/or subsequently to step a), placing a shaping tool in contact with the thus coated eyelashes so as to modify the curvature of the eyelashes, for a sufficient time to induce the crosslinking of said deposit.

According to one alternative, the first and second compositions are mixed before application to the keratin fibres.

According to a second alternative, the first and second compositions are mixed in situ at the time of application to the keratin fibres.

Compounds Based on Alginic Acid

The expression “compound based on alginic acid” is understood in particular to mean alginic acid, alginic acid derivatives and the salts of alginic acid (alginates) or of said derivatives.

Preferably, the compound based on alginic acid is water-soluble.

Alginic acid, a natural substance resulting from brown algae or certain bacteria, is a polyuronic acid composed of 2 uronic acids linked by 1,4-glycosidic bonds: 13-D-manuronic (M) acid and α-L-glucuronic (G) acid.

Alginic acid is capable of forming water-soluble salts (alginates) with alkali metals such as sodium, potassium or lithium, substituted cations of lower amines and of ammonium such as methylamine, ethanolamine, diethanolamine or triethanolamine. These alginates are water-soluble in aqueous medium at pH 4 but dissociate into alginic acid at a pH below 4.

These alginates are capable of crosslinking together in the presence of complexing agents, by forming ionic bonds between said complexing agents and the negatively charged group of the residue G. The formation of multiple crosslinks between several alginate molecules leads to the formation of a matrix that forms a gel which is insoluble in water.

Use is preferably made of compounds based on alginic acid that have a weight-average molecular weight ranging from 10 000 to 1 000 000, preferably from 15 000 to 500 000 and better still from 20 000 to 250 000.

According to one preferred embodiment, the compound based on alginic acid is a sodium or potassium alginate.

The compound based on alginic acid may be present in a content ranging from 0.1% to 30% by weight, preferably from 0.5% to 20% by weight and better still from 1% to 10% by weight relative to the total weight of the composition comprising it.

### Complexing Agent

The complexing agent is capable of becoming complexed with the compound based on alginic acid by formation of an ionic bond. This complexation is reversible.

The complexing agent may be chosen in particular from cationic polyelectrolytes and multivalent ions and salts thereof, in particular the salts of multivalent cations or of polycations. It is preferably in water-soluble form in the second composition.

The multivalent ions may in particular be cations such as polycations or multivalent cations, preferably having a valency ranging from 2 to 4 and more preferably divalent cations, in particular calcium, magnesium, aluminium, barium, zinc, nickel, copper (+II) and manganese cations, and mixtures thereof. Mention may be made especially of the chlorides or sulphates of the cations mentioned above and in particular chlorides such as calcium chloride.

As polyelectrolytes, mention may, for example, be made of polyamines such as poly(ethyleneimine) also referred to as poly(ethyleneamine), poly(L-lysine), poly(L-glutamine), polyvinylamine or chitosan and quaternized polyamines such as 2-hydroxy-1-propyl-N-methylammonium polychloride, 2-hydroxy-1-propyl-1,N-dimethylammonium polychloride, 2-vinylimidazolinium polyhydrogenosulphate or diallyldimethylammonium polychloride.

The complexing agent(s) may be present in a content ranging from 0.01% to 30% by weight, preferably from 0.02% to 15% by weight and better still from 0.05% to 5% by weight relative to the total weight of the composition.

The rate of reaction between the polysaccharide and the complexing agent may be modulated by modifying the pH and/or temperature conditions of the composition, or alternatively by adding a compound that can accelerate or slow down the reaction between the polysaccharide and the complexing agent, for instance sodium phosphate, which can slow down the crosslinking of the alginic acid-based derivative.

### Oils

The composition may comprise at least one oil. Such a component, when it is volatile, evaporates during the drying of the composition according to the invention.

The term “volatile oil” is understood, within the meaning of the invention, to mean volatile cosmetic oils that are liquid at room temperature, with a non-zero vapour pressure at room temperature and atmospheric pressure, ranging in particular from 10⁻² to 300 mmHg (1.33 Pa to 40 000 Pa) and preferably greater than 0.3 mmHg (30 Pa).

The term “non-volatile oil” means an oil that has a vapour pressure of less than 10⁻² mmHg (1.33 Pa).

These oils may be hydrocarbon-based oils, silicone oils or fluoro oils, or mixtures thereof.

The term “hydrocarbon-based oil” means an oil mainly containing hydrogen and carbon atoms and optionally oxygen, nitrogen, sulphur or phosphorus atoms. Volatile hydrocarbon-based oils may be chosen from hydrocarbon-based oils containing from 8 to 16 carbon atoms, and especially branched C₈-C₁₆ alkanes, for instance C₈-C₁₆ isoalkanes of petroleum origin (also known as isoparaffins), for instance isododecane (also known as 2,2,4,4,6-pentamethylheptane), isodecane and isohexadecane, and for example the oils sold under the trade names Isopar or Permethyl, branched C₈-C₁₆ esters and isohexyl neopentanoate, and mixtures thereof. Other volatile hydrocarbon-based oils, for instance petroleum distillates, especially those sold under the name Shell Solt by the company Shell, may also be used. The volatile solvent is preferably chosen from volatile hydrocarbon-based oils containing from 8 to 16 carbon atoms, and mixtures thereof.

Volatile oils that may also be used include volatile silicones, for instance volatile linear or cyclic silicone oils, especially those with a viscosity ≦8 centistokes (8 10⁻⁶ m²/s) and especially containing from 2 to 7 silicon atoms, these silicones optionally comprising alkyl or alkoxy groups containing from 1 to 10 carbon atoms. As volatile silicone oils that may be used in the invention, mention may be made especially of octamethylcyclotetrasiloxane, decamethylcyclopentasiloxane, dodecamethylcyclohexasiloxane, heptamethylhexyltrisiloxane, heptamethyloctyltrisiloxane, hexamethyldisiloxane, octamethyltrisiloxane, decamethyltetrasiloxane and dodecamethylpentasiloxane, and mixtures thereof.

Volatile fluoro solvents such as 1,1,1,2,2,3,4,5,5,5-decafluoropentane or perfluoromethylcyclopentane may also be used.

The volatile oil may be present in the composition according to the invention in a content ranging from 1% to 95% by weight, and preferably from 1% to 65% by weight, relative to the total weight of the composition.

The composition may also comprise at least one non-volatile oil chosen especially from non-volatile hydrocarbon-based oils and/or silicone oils and/or fluoro oils.

Non-volatile hydrocarbon-based oils that may especially be mentioned include:
hydrocarbon-based oils of plant origin such as triglycerides consisting of fatty acid esters of glycerol, the fatty acids of which may have chain lengths varying from C₄ to C₂₄, these chains possibly being linear or branched, and saturated or unsaturated; these oils are especially wheatgerm oil, sunflower oil, grapeseed oil, sesame seed oil, corn oil, apricot oil, castor oil, shea oil, avocado oil, olive oil, soybean oil, sweet almond oil, palm oil, rapeseed oil, cottonseed oil, hazelnut oil, macadamia oil, jojoba oil, alfalfa oil, poppy oil, pumpkin oil, marrow oil, blackcurrant oil, evening primrose oil, millet oil, barley oil, quinoa oil, rye oil, safflower oil, candlenut oil, passion flower oil and musk rose oil; or else caprylic/capric acid triglycerides, for instance those sold by the company Stéarineries Dubois or those sold under the names Miglyol 810, 812 and 818 by the company Dynamit Nobel,
synthetic ethers containing from 10 to 40 carbon atoms;
linear or branched hydrocarbons, of mineral or synthetic origin, such as petroleum jelly, polydecenes, hydrogenated polyisobutene such as Parleam, and squalane;
synthetic esters such as oils of formula RiCOOR₂ in which R₁ represents a linear or branched fatty acid residue containing from 1 to 40 carbon atoms and R₂ represents an in particular branched hydrocarbon-based chain containing from 1 to 40 carbon atoms, on condition that R₅+R₆≧10, for instance purcellin oil (cetostearyl octanoate), isopropyl myristate, isopropyl palmitate, C₁₂ to C₁₅ alkyl benzoate, hexyl laurate, diisopropyl adipate, isononyl isononanoate, 2-ethylhexyl palmitate, isostearyl isostearate, alkyl or polyalkyl oc-tanoates, decanoates or ricinoleates such as propylene glycol dioctanoate; hydroxylated esters such as isostearyl lactate and diisostearyl malate; and pentaerythritol esters;
fatty alcohols that are liquid at room temperature, with a branched and/or unsaturated carbon-based chain containing from 12 to 26 carbon atoms, for instance octyldodecanol, isostearyl alcohol, oleyl alcohol, 2-hexyldecanol, 2-butyloctanol and 2-undecylpentadecanol;
higher fatty acids such as oleic acid, linoleic acid or linolenic acid;
the dicaprylyl carbonate sold under the name CETIOL CC by the company COGNIS; and mixtures thereof.

The non-volatile silicone oils that can be used in the composition according to the invention may be non-volatile polydimethylsiloxanes (PDMSs), polydimethylsiloxanes comprising alkyl or alkoxy groups that are pendent and/or at the end of a silicone chain, these groups each containing from 2 to 24 carbon atoms, phenylsilicones, for instance phenyl trimethicones, phenyl dimethicones, phenyltrimethylsiloxydiphenylsiloxanes, diphenyl dimethicones, diphenylmethyldiphenyltrisiloxanes, and 2-phenylethyltrimethyl siloxysilicates, and mixtures thereof.

The fluoro oils that can be used in the invention are in particular fluorosilicone oils, fluoro polyethers and fluorosilicones as described in document EP-A-847 752.

The non-volatile oils may be present in the composition according to the invention in a content ranging from 0.1% to 80% by weight, preferably ranging from 0.1% to 50% by weight and preferentially ranging from 0.1% to 20% by weight relative to the total weight of the composition.

### Waxes

The term “wax” is understood, within the meaning of the present invention, to mean a lipophilic compound, which is solid at room temperature (25° C.), with a reversible solid/liquid change of state, which has a melting point of greater than or equal to 30° C., which may be up to 120° C.

The melting point of the wax may be measured using a differential scanning calorimeter (DSC), for example the calorimeter sold under the name DSC 30 by the company Mettler. The waxes may be hydrocarbon-based waxes, fluoro waxes and/or silicone waxes, and may be of plant, mineral, animal and/or synthetic origin. In particular, the waxes have a melting point of greater than 25° C. and better still greater than 45° C.

When the composition according to the invention comprises at least one wax, the latter may be present in a content at least equal to 5% by weight. Preferably, it is present in a content ranging from 10% to 50% by weight, better still from 10% to 40% by weight and even better still from 15% to 30% by weight relative to the total weight of the composition. Hydrocarbon-based waxes, for instance beeswax, lanolin wax or Chinese insect wax; rice wax, carnauba wax, candelilla wax, ouricury wax, esparto grass wax, cork fibre wax, sugar cane wax, Japan wax and sumach wax; montan wax, microcrystalline waxes, paraffins and ozokerite; polyethylene waxes, the waxes obtained by Fisher-Tropsch synthesis and waxy copolymers, and also esters thereof, may especially be used. Mention may also be made of waxes obtained by catalytic hydrogenation of animal or plant oils containing linear or branched C₈-C₃₂ fatty chains.

Among these waxes, mention may especially be made of hydrogenated jojoba oil, hydrogenated sunflower oil, hydrogenated castor oil, hydrogenated coconut oil, hydrogenated lanolin oil and bis(1,1,1-trimethylolpropane)tetrastearate sold under the name Hest 2T-4S by the company Heterene, bis(1,1,1-trimethylolpropane)tetrabehenate sold under the name Hest 2T-4B by the company Heterene.

Mention may also be made of silicone waxes, for instance alkyl or alkoxy dimethicones containing from 16 to 45 carbon atoms, and fluoro waxes.

The wax obtained by hydrogenation of olive oil esterified with stearyl alcohol, sold under the name Phytowax Olive 18L57 or else the waxes obtained by hydrogenation of castor oil esterified with cetyl alcohol sold under the names Phytowax ricin 16L64 and 22L73 by the company Sophim may also be used. Such waxes are described in patent application FR-A-2 792 190.

According to one particular embodiment, the compositions according to the invention may comprise at least one wax referred to as a tacky wax, i.e. a wax with a tack of greater than or equal to 0.7 N·s and a hardness of less than or equal to 3.5 MPa.

Using a tacky wax may especially make it possible to obtain a cosmetic composition that applies easily to the eyelashes, attaches well to the eyelashes and leads to the formation of a smooth, uniform and thickening makeup result.

The tacky wax used may especially have a tack ranging from 0.7 N·s to 30 N·s, in particular greater than or equal to 1 N·s, especially ranging from 1 N·s to 20 N·s, in particular greater than or equal to 2 N·s, especially ranging from 2 N·s to 10 N·s and in particular ranging from 2 N·s to 5 N·s.

The tack of the wax is determined by measuring the change in force (compression force or stretching force) as a function of time, at 20° C., using the texturometer sold under the name TA-TX21® by Rheo, equipped with a conical acrylic polymer spindle forming an angle of 45°.

The measuring protocol is as follows:

The wax is melted at a temperature equal to the melting point of the wax +10° C. The molten wax is poured into a container 25 mm in diameter and 20 mm deep. The wax is recrystallized at room temperature (25° C.) for 24 hours such that the surface of the wax is flat and smooth, and the wax is then stored for at least 1 hour at 20° C. before measuring the tack.

The texturometer spindle is displaced at a speed of 0.5 mm/s, then penetrates the wax to a penetration depth of 2 mm. When the spindle has penetrated the wax to a depth of 2 mm, the spindle is held still for 1 second (corresponding to the relaxation time) and is then withdrawn at a speed of 0.5 mm/s.

During the relaxation time, the force (compression force) decreases greatly until it becomes zero, and then, during the withdrawal of the spindle, the force (stretching force) becomes negative and then rises again to the value 0. The tack corresponds to the integral of the curve of the force as a function of time for the part of the curve corresponding to negative values of the force (stretching force). The tack value is expressed in N·s.

The tacky wax that may be used generally has a hardness of less than or equal to 3.5 MPa, in particular ranging from 0.01 MPa to 3.5 MPa, especially ranging from 0.05 MPa to 3 MPa or even ranging from 0.1 MPa to 2.5 MPa.

The hardness is measured according to the protocol described previously.

Tacky waxes that may be used include a C₂₀-C₄₀ alkyl (hydroxystearyloxy)stearate (the alkyl group comprising from 20 to 40 carbon atoms), alone or as a mixture, in particular a C₂₀-C₄₀ alkyl 12-(12′-hydroxystearyloxy)stearate, of formula (II):

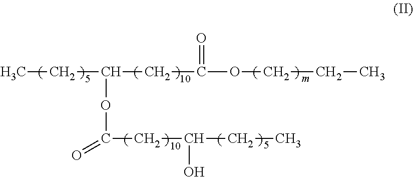

in which m is an integer ranging from 18 to 38, or a mixture of compounds of formula (II).

Such a wax is especially sold under the names Kester Wax K 82 PO and Kester Wax K 80 PO by the company Koster Keunen.

The waxes mentioned above generally have a starting melting point of less than 45° C. Use may also be made of the microcrystalline wax sold under the reference SP18 by Strahl and Pitsch, which has a hardness of around 0.46 MPa and a tack value of around 1N·s.

The wax(es) may be present in the form of an aqueous wax microdispersion. The term “aqueous wax microdispersion” means an aqueous dispersion of wax particles, in which the size of said wax particles is less than or equal to about 1 μm.

Wax microdispersions are stable dispersions of colloidal wax particles, and are described especially in Microemulsions Theory and Practice, L. M. Prince Ed., Academic Press (1977) pages 21-32.

In particular, these wax microdispersions may be obtained by melting the wax in the presence of a surfactant, and optionally of some of the water, followed by gradual addition of hot water with stirring. Intermediate formation of an emulsion of the water-in-oil type is observed, followed by a phase inversion with final production of a microemulsion of the oil-in-water type. On cooling, a stable microdispersion of solid colloidal wax particles is obtained.

The wax microdispersions may also be obtained by stirring the mixture of wax, surfactant and water using an agitation means such as ultrasonic waves, a high-pressure homogenizer or turbomixers.

The particles of the wax microdispersion preferably have mean sizes of less than 1 μm (especially ranging from 0.02 μm to 0.99 μm), preferably less than 0.5 μm (especially ranging from 0.06 μm to 0.5 μm).

These particles are formed essentially from a wax or a mixture of waxes. They may, however, comprise a minor proportion of oily and/or pasty fatty additives, a surfactant and/or a common additive/fat-soluble active agent.

### Film-Forming Polymers

In the present application, the term “film-forming polymer” means a polymer that is capable of forming, by itself or in the presence of an auxiliary film-forming agent, a continuous and adherent film on a support, especially on keratin materials.

Use is preferably made of a film-forming polymer capable of forming a hydrophobic film, i.e. a polymer for which the film has a solubility in water at 25° C. of less than 1% by weight.

Among the film-forming polymers that may be used in the composition of the present invention, mention may be made of synthetic polymers, of free-radical type or of polycondensate type, polymers of natural origin, and mixtures thereof.

The expression “free-radical film-forming polymer” means a polymer obtained by polymerization of unsaturated and especially ethylenically unsaturated monomers, each monomer being capable of homopolymerizing (unlike polycondensates). The film-forming polymers of free-radical type may especially be vinyl polymers or copolymers, especially (meth)acrylic polymers in acid, ester or amide form.

According to the present invention, the alkyl group of the esters may be either fluorinated or perfluorinated, i.e. some or all of the hydrogen atoms of the alkyl group are substituted with fluorine atoms.

The vinyl film-forming polymers may also result from the homopolymerization or copolymerization of monomers chosen from vinyl esters and styrene monomers. In particular, these monomers may be polymerized with acid monomers and/or esters thereof and/or amides thereof, such as those mentioned previously.

It is possible to use any monomer known to those skilled in the art included in the categories of acrylic and vinyl monomers (including monomers modified with a silicone chain).

Among the film-forming polycondensates that may be mentioned are polyurethanes, polyesters, polyester-amides, polyamides, epoxyester resins and polyureas.

Use may be made of copolymers based on isophthalate/sulphoisophthalate, and more particularly copolymers obtained by condensation of diethylene glycol, cyclohexanedimethanol, isophthalic acid and sulphoisophthalic acid. Such polymers are sold for example under the trade name Eastman AQ® by the company Eastman Chemical Products.

The polymers of natural origin, optionally modified, may be chosen from shellac resin, sandarac gum, dammar resins, elemi gums, copal resins and cellulose-based polymers, and mixtures thereof.

According to a first embodiment of the composition according to the invention, the additional film-forming polymer may be present in the form of particles in aqueous dispersion, which is generally known as a latex or pseudolatex. Techniques for preparing these dispersions are well known to those skilled in the art.

Aqueous dispersions of film-forming polymer that may be used include the acrylic dispersions sold under the names Neocryl XK-90®, Neocryl A-1070®, Neocryl A-1090®, Neocryl BT-62®, Neocryl A-1079®, Neocryl A-523® by the company Avecia-Neoresins, Dow Latex 432® by the company Dow Chemical, Daitosol 5000 AD® by the company Daito Kasey Kogyo; or else the aqueous polyurethane dispersions sold under the names Neorez R-981®, Neorez R-974® by the company Avecia-Neoresins, Avalure UR-405®, Avalure UR-410®, Avalure UR-425®, Avalure UR-450®, Sancure 875®, Sancure 861®, Sancure 878®, Sancure 2060® by the company Goodrich, Impranil 85® by the company Bayer, Aquamere H-1511® by the company Hydromer.

Use may also be made, as aqueous dispersions of film-forming polymer, of the dispersions of polymers resulting from the free-radical polymerization of one or more free-radical monomers inside and/or partially at the surface of pre-existing particles of at least one polymer chosen from the group consisting of polyurethanes, polyureas, polyesters, polyesteramides and/or alkyds. These polymers are generally referred to as “hybrid polymers”.

According to a second embodiment variant of the composition according to the invention, the additional film-forming polymer may be a water-soluble polymer and is therefore present in an aqueous phase of the composition in solubilized form. Examples of water-soluble film-forming polymers that may be mentioned include:
proteins, for instance proteins of plant origin such as wheat proteins and soybean proteins; proteins of animal origin such as keratins, for example keratin hydrolysates and sulphonic keratins;
anionic, cationic, amphoteric or nonionic chitin or chitosan polymers;
cellulose polymers such as hydroxyethyl cellulose, hydroxypropyl cellulose, methyl cellulose, ethyl hydroxyethyl cellulose and carboxymethyl cellulose, and also quaternized cellulose derivatives;
acrylic polymers or copolymers, such as polyacrylates or polymethacrylates;
vinyl polymers, for instance polyvinylpyrrolidones, copolymers of methyl vinyl ether and of malic anhydride, the copolymer of vinyl acetate and of crotonic acid, copolymers of vinylpyrrolidone and of vinyl acetate; copolymers of vinylpyrrolidone and of caprolactam; polyvinyl alcohol;
optionally modified polymers of natural origin, such as:
gum arabic, guar gum, xanthan derivatives, karaya gum;
alginates and carrageenans;
glycosaminoglycans, hyaluronic acid and derivatives thereof;
shellac resin, sandarac gum, dammar resins, elemi gums and copal resins;
deoxyribonucleic acid;
mucopolysaccharides such as hyaluronic acid and chondroitin sulphates, and mixtures thereof.

According to another embodiment variant of the composition according to the invention, the film-forming polymer may be present in a liquid fatty phase comprising organic solvents or oils such as those described above. The expression “liquid fatty phase” is understood to mean, within the meaning of the invention, a fatty phase that is liquid at room temperature (25° C.) and atmospheric pressure (760 mmHg, i.e. 10⁵ Pa), composed of one or more fatty substances that are liquid at room temperature, also known as oils, generally that are compatible with one another.

Preferably, the liquid fatty phase comprises a volatile oil, optionally mixed with a non-volatile oil, the oils possibly being chosen from the oils mentioned above.

According to a third embodiment of the composition according to the invention, the additional film-forming polymer may be present in the form of surface-stabilized particles that are dispersed in a liquid fatty phase.

The dispersion of surface-stabilized polymer particles may be manufactured as described in document EP-A-749 747.

The polymer particles are surface-stabilized by means of a stabilizer that may be a block polymer, a grafted polymer and/or a random polymer, alone or as a mixture.

Dispersions of film-forming polymer in the liquid fatty phase, in the presence of stabilizers, are especially described in documents EP-A-749 746, EP-A-923 928 and EP-A-930 060, the content of which is incorporated by reference into the present patent application.

The size of the polymer particles in dispersion, either in the aqueous phase or in the liquid fatty phase, may range from 5 nm to 600 nm, and preferably from 20 nm to 300 nm.

According to a fourth embodiment of the composition according to the invention, the additional film-forming polymer may be solubilized in a liquid fatty phase, in which case the film-forming polymer is said to be a fat-soluble polymer.

Examples of fat-soluble polymers that may be mentioned are copolymers of vinyl ester (the vinyl group being directly linked to the oxygen atom of the ester group and the vinyl ester containing a saturated, linear or branched hydrocarbon-based radical of 1 to 19 carbon atoms, linked to the carbonyl of the ester group) and of at least one other monomer which may be a vinyl ester (other than the vinyl ester already present), an α-olefin (containing from 8 to 28 carbon atoms), an alkyl vinyl ether (in which the alkyl group comprises from 2 to 18 carbon atoms) or an allylic or methallylic ester (containing a saturated, linear or branched hydrocarbon-based radical of 1 to 19 carbon atoms, linked to the carbonyl of the ester group).

These copolymers may be crosslinked with the aid of crosslinking agents, which may be either of the vinyl type or of the allylic or methallylic type, such as tetraallyloxyethane, divinylbenzene, divinyl octanedioate, divinyl dodecanedioate and divinyl octadecanedioate.

Fat-soluble film-forming polymers that may also be mentioned include fat-soluble homopolymers, and in particular those resulting from the homopolymerization of vinyl esters containing from 9 to 22 carbon atoms or of alkyl acrylates or methacrylates, the alkyl radicals containing from 10 to 20 carbon atoms.

The fat-soluble copolymers and homopolymers defined above are known and described especially in patent application FR-A-2 262 303; they may have a weight-average molecular weight ranging from 2000 to 500 000 and preferably from 4000 to 200 000.

As fat-soluble film-forming polymers that may be used in the invention, mention may also be made of polyalkylenes and in particular copolymers of C₂-C₂₀ alkenes, such as polybutene, alkyl celluloses with a linear or branched, saturated or unsaturated C₁-C₈ alkyl radical, for instance ethyl cellulose and propyl cellulose, copolymers of vinylpyrrolidone (VP) and in particular copolymers of vinylpyrrolidone and of C₂ to C₄₀ and better still C₃ to C₂₀ alkene.

According to one preferred embodiment of the composition according to the invention, the additional film-forming polymer may be a polymer capable of forming a deposit, especially a film, producing, at a concentration of 7% in water, a shrinkage of isolated stratum corneum of greater than 1% at 30° C. under a relative humidity of 40%, preferably of more than 1.2% and better still of more than 1.5%. This shrinkage is measured using an extensiometer according to the method described below.

The composition according to the invention may comprise an auxiliary film-forming agent to allow the formation of a film, at room temperature, of the multiphase particles according to the invention or of the additional film-forming polymer. The auxiliary agent may be a coalescer or a plasticizer known to those skilled in the art. A plasticizer is generally an organic compound that remains in the composition during the formation of the film. A coalescer is generally a volatile organic compound that evaporates during the formation of the film.

### Surfactants

The composition according to the invention may contain surfactants, which are especially present in a proportion ranging from 2% to 30% by weight, better still from 5% to 15%, relative to the total weight of the composition.

According to the invention, use is generally made of a surfactant chosen in a manner appropriate for obtaining a wax-in-water or oil-in-water emulsion. In particular, it is possible to use an emulsifier that has, at 25° C., an HLB balance (hydrophilic-lipophilic balance), within the Griffin meaning, of greater than or equal to 8.

The Griffin HLB value is defined in J. Soc. Cosm. Chem. 1954 (volume 5), pages 249-256.

These surfactants may be chosen from nonionic, anionic, cationic or amphoteric surfactants or else surfactant emulsifiers. Reference may be made to the document “Encyclopedia of Chemical Technology, Kirk-Othmer”, Volume 22, pp. 333-432, 3rd Edition, 1979, Wiley, for the definition of the (emulsifying) properties and functions of surfactants, in particular pp. 347-377 of this reference, for the anionic, amphoteric and nonionic surfactants.

The surfactants preferentially used in the composition according to the invention are chosen from:

a) nonionic surfactants with an HLB of greater than or equal to 8 at 25° C., used alone or as a mixture; mention may be made especially of:
saccharide esters and ethers such as the mixture of cetylstearyl glucoside and of cetyl and stearyl alcohols, for instance Montanov 68 from SEPPIC;
oxyethylenated and/or oxypropylenated ethers (which may comprise from 1 to 150 oxyethylene and/or oxypropylene groups) of glycerol;
oxyethylenated and/or oxypropylenated ethers (which may comprise from 1 to 150 oxyethylene and/or oxypropylene groups) of fatty alcohols (especially of C₈-C₂₄ and preferably C₁₂-C₁₈ alcohol), such as oxyethylenated cetearyl alcohol ether containing 30 oxyethylene groups (CTFA name Ceteareth-30), the oxyethylenated ether of stearyl alcohol containing 20 oxyethylene groups (CTFA name Steareth-20) and the oxyethylenated ether of the mixture of C12-C15 fatty alcohols comprising 7 oxyethylene groups (CTFA name C12-15 Pareth-7) sold under the name Neodol 25-7® by Shell Chemicals;
fatty acid esters (especially of a C₈-C₂₄ and preferably C16-C22 acid) of polyethylene glycol (which may comprise from 1 to 150 ethylene glycol units), such as PEG-50 stearate and PEG-40 monostearate sold under the name Myrj 52P® by the company ICI Uniqema;
fatty acid esters (especially of a C₈-C₂₄ and preferably C16-C22 acid) of oxyethylenated and/or oxypropylenated glyceryl ethers (which may comprise from 1 to 150 oxyethylene and/or oxypropylene groups), for instance PEG-200 glyceryl monostearate sold under the name Simulsol 220 TM® by the company SEPPIC; glyceryl stearate polyethoxylated with 30 ethylene oxide groups, for instance the product Tagat S® sold by the company Goldschmidt, glyceryl oleate polyethoxylated with 30 ethylene oxide groups, for instance the product Tagat O® sold by the company Goldschmidt, glyceryl cocoate polyethoxylated with 30 ethylene oxide groups, for instance the product Vanonic LI 13® sold by the company Sherex, glyceryl isostearate polyethoxylated with 30 ethylene oxide groups, for instance the product Tagat L® sold by the company Goldschmidt, and glyceryl laurate polyethoxylated with 30 ethylene oxide groups, for instance the product Tagat I® from the company Goldschmidt;
fatty acid esters (especially of a C₈-C₂₄ and preferably C16-C22 acid) of oxyethylenated and/or oxypropylenated sorbitol ethers (which may comprise from 1 to 150 oxyethylene and/or oxypropylene groups), for instance polysorbate 20 sold under the name Tween 20® by the company Croda and polysorbate 60 sold under the name Tween 60® by the company Croda;
dimethicone copolyol, such as the product sold under the name Q2-5220® by the company Dow Corning;
dimethicone copolyol benzoate (Finsolv SLB 101® and 201® by the company Finetex);
copolymers of propylene oxide and of ethylene oxide, also known as EO/PO polycondensates;
and mixtures thereof.

EO/PO polycondensates are more particularly copolymers formed from polyethylene glycol and polypropylene glycol blocks, for instance polyethylene glycol/polypropylene glycol/polyethylene glycol triblock polycondensates. These triblock polycondensates have, for example, the following chemical structure:

H—(O—CH₂—CH₂)ₐ—(O—CH(CH₃)—CH₂)_{b}—(O—CH₂—CH₂)ₐ—OH,

in which formula a ranges from 2 to 120 and b ranges from 1 to 100.

The EO/PO polycondensate preferably has a weight-average molecular weight ranging from 1000 to 15 000 and better still ranging from 2000 to 13 000. Advantageously, said EO/PO polycondensate has a cloud point, at 10 g/l in distilled water, of greater than or equal to 20° C., preferably of greater than or equal to 60° C. The cloud point is measured according to the standard ISO 1065. Mention may be made, as EO/PO polycondensate which can be used according to the invention, of the polyethylene glycol/polypropylene glycol/polyethylene glycol triblock polycondensates sold under the Synperonic® names, such as Synperonic PE/L44® and Synperonic PE/F127®, by ICI.

b) nonionic surfactants with an HLB of less than 8 at 25° C., optionally combined with one or more nonionic surfactants with an HLB of greater than 8 at 25° C., as mentioned above, such as:
saccharide esters and ethers, such as sucrose stearate, sucrose cocoate and sorbitan stearate, and mixtures thereof, for instance Arlatone 2121® sold by the company ICI;
oxyethylenated and/or oxypropylenated ethers (which may comprise 1 to 150 oxyethylene and/or oxypropylene groups) of fatty alcohols (especially of C₈-C₂₄ and preferably C₁₂-C₁₈ alcohols) such as stearyl alcohol oxyethylene ether containing two oxyethylene groups (CTFA name: “Steareth-2”);
fatty acid esters (especially of a C₈-C₂₄ and preferably C16-C22 acid) of polyols, especially of glycerol or of sorbitol, such as glyceryl stearate, glyceryl stearate such as the product sold under the name Tegin M® by the company Goldschmidt, glyceryl laurate such as the product sold under the name Imwitor 312® by the company Hüls, polyglyceryl-2 stearate, sorbitan tristearate or glyceryl ricinoleate;
lecithins, such as soybean lecithins (for instance Emulmetik 100 J from Cargill, or Biophilic H from Lucas Meyer);

the mixture of cyclomethicone/dimethicone copolyol sold under the name Q2-3225C® by the company Dow Corning.

c) anionic surfactants such as:
salts of C16-C30 fatty acids, in particular those derived from amines such as triethanolamine stearate and/or 2-amino-2-methylpropane-1,3-diol stearate;
polyoxyethylenated fatty acid salts, especially those derived from amines or alkali metal salts, and mixtures thereof;
phosphoric esters and salts thereof, such as DEA oleth-10 phosphate (Crodafos N 10N from the company Croda) or monopotassium monocetyl phosphate (Amphisol K from the company Givaudan);

sulphosuccinates such as Disodium PEG-5 citrate lauryl sulphosuccinate and Disodium ricinoleamido MEA sulphosuccinate;
alkyl ether sulphates, such as sodium lauryl ether sulphate;
isethionates;
acylglutamates such as Disodium hydrogenated tallow glutamate (Amisoft HS-21 R® from Ajinomoto) and sodium stearoyl glutamate (Amisoft HS-11 PF® from Ajinomoto) and mixtures thereof;
soybean derivatives, for instance potassium soyate;
citrates, for instance glyceryl stearate citrate (Axol C 62 Pellets from Degussa);
proline derivatives, for instance sodium palmitoyl proline (Sepicalm VG from SEPPIC) or the mixture of sodium palmitoyl sarcosinate, magnesium palmitoyl glutamate, palmitic acid and palmitoyl proline (Sepifeel One from SEPPIC);
lactylates, such as sodium stearoyl lactylate (Akoline SL from Karlshamns AB);

sarcosinates, such as sodium palmitoyl sarcosinate (Nikkol sarcosinate PN), or the mixture of stearoyl sarcosine and myristoyl sarcosine 75/25 (Crodasin SM from Croda);
sulphonates, such as sodium C14-17 alkyl-sec-sulphonate (Hostapur SAS 60 from Clariant);
glycinates, such as sodium cocoyl glycinate (Amilite GCS-12 from Ajinomoto).

Triethanolamine stearate is most particularly suitable for the invention. This is generally obtained by simple mixing of stearic acid and triethanolamine.

The compositions according to the invention may also contain one or more amphoteric surfactants, for instance N-acylamino acids, such as N-alkylaminoacetates and disodium cocoamphodiacetate, and amine oxides, such as stearamine oxide, or else silicone surfactants, for instance dimethicone copolyol phosphates, such as that sold under the name Pecosil PS100® by the company PHOENIX CHEMICAL.

The surfactant that can be used may also be a polymeric surfactant, in particular a thermogelling polymer.

### Pulverulent Compounds

The compositions may also comprise at least one dyestuff such as pulverulent compounds, for example in a proportion of from 0.01% to 25% of the total weight of the composition. The pulverulent compounds may be chosen from the pigments and/or nacres usually used in mascaras.

The pigments may be white or coloured, and mineral and/or organic. Among the mineral pigments, mention may be made of titanium dioxide, optionally surface-treated, zirconium oxide or cerium oxide, and also iron oxide or chromium oxide, manganese violet, ultramarine blue, chromium hydrate and ferric blue. Among the organic pigments that may be mentioned are carbon black, pigments of D & C type, and lakes based on cochineal carmine or on barium, strontium, calcium or aluminium.

The nacreous pigments may be chosen from white nacreous pigments such as mica coated with titanium or with bismuth oxychloride, coloured nacreous pigments such as titanium mica coated with iron oxides, titanium mica coated especially with ferric blue or with chromium oxide, titanium mica coated with an organic pigment of the abovementioned type and also nacreous pigments based on bismuth oxychloride.

The compositions according to the invention may also comprise fillers that may be selected from those that are well known to those skilled in the art and commonly used in cosmetic compositions. As filler, use may especially be made of:
talc, which is a hydrated magnesium silicate used in the form of particles generally less than 40 microns,
micas, which are aluminosilicates of varied compositions, present in the form of flakes from 2 to 200 microns in size, preferably from 5 to 70 microns in size, and between 0.1 and 5 microns thick, preferably from 0.2 to 3 microns thick, it being possible for these micas to be of natural origin, such as muscovite, margarite, roscoelite, lepidolite or biotite, or of synthetic origin,
starch, in particular rice starch,
kaolin, which is a hydrated aluminium silicate that is present in the form of particles of isotropic shape which are generally less than 30 microns in size,
zinc oxide and titanium oxide, which are generally used in the form of particles not exceeding a few microns in size,
calcium carbonate, magnesium carbonate or magnesium hydrocarbonate,
microcrystalline cellulose,
silica,
powders of synthetic polymers such as polyethylene, polyesters (polyethylene isophthalate or terephthalate), polyamides such as those sold under the trade name “Nylon” or “Teflon”, and silicone powders.

The compositions according to the invention may also comprise fibres.

The term “fibre” should be understood as meaning an object of length L and of diameter D such that L is very much greater than D, D being the diameter of the circle in which the cross section of the fibre is inscribed. In particular, the ratio L/D (or aspect ratio) is chosen in the range from 3.5 to 2500, in particular from 5 to 500 and more particularly from 5 to 150.

The fibres that may be used in the composition of the invention may be mineral or organic fibres, of synthetic or natural origin. They may be short or long, individual or organized, for example braided, and hollow or solid. They may have any shape and may especially have a circular or polygonal (square, hexagonal or octagonal) cross section depending on the specific application envisaged. In particular, their ends are blunted and/or polished to prevent injury.

In particular, the fibres have a length ranging from 1 μm to 10 mm, in particular from 0.1 mm to 5 mm and more particularly from 0.3 mm to 3.5 mm. Their cross section may be included in a circle with a diameter ranging from 2 nm to 500 μm, in particular ranging from 100 nm to 100 μm and more particularly from 1 μm to 50 μm. The weight or yarn count of fibres is often given in denier or decitex and represents the weight in grams per 9 km of yarn. The fibres according to the invention can in particular have a count chosen within the range from 0.15 to 30 denier and especially from 0.18 to 18 denier.

The fibres that may be used in the composition of the invention may be chosen from rigid or non-rigid fibres, and may be mineral or organic fibres, of synthetic or natural origin.

Moreover, the fibres may or may not be surface-treated, may be coated or uncoated, and may be coloured or uncoloured.

As fibres that may be used in the composition according to the invention, mention may be made of non-rigid fibres such as polyamide (Nylon®) fibres or rigid fibres such as polyimideamide fibres, for instance those sold under the names Kermel® and Kermel Tech® by the company Rhodia or poly(p-phenyleneterephthalamide) (or aramid) fibres sold especially under the name Kevlar® by the company DuPont de Nemours.

The fibres may be present in the composition according to the invention in a content ranging from 0.01% to 10% by weight, in particular ranging from 0.1% to 5% by weight and more particularly ranging from 0.3% to 3% by weight relative to the total weight of the composition.

The compositions according to the invention may also contain ingredients commonly used in cosmetics, such as trace elements, softeners, sequestering agents, fragrances, vitamins, proteins, ceramides, basifying or acidifying agents usually used in cosmetics, emollients, preserving agents, sunscreens and antioxidants.

Needless to say, a person skilled in the art will take care to select this or these optional additional compound(s), and/or the amount thereof, such that the advantageous properties of the composition according to the invention are not, or are not substantially, adversely affected by the envisaged addition.

The compositions according to the invention may be in the form of a solution, a dispersion or a wax-in-water, water-in-wax, oil-in-water or water-in-oil emulsion. The second composition may also be in anhydrous form, i.e. comprising less than 10% water, preferably less than 5% water.

The compositions according to the invention may each be packaged in a container delimiting at least one compartment that comprises said composition, said container being closed by a closing member.

The container is preferably combined with an applicator, especially in the form of a brush comprising an arrangement of bristles held by a twisted wire. Such a twisted brush is described especially in patent U.S. Pat. No. 4,887,622. It may also be in the form of a comb comprising a plurality of application members, obtained especially by moulding. Such combs are described, for example, in patent FR 2 796 529. The applicator may be solidly attached to the container, as described, for example, in patent FR 2 761 959. Advantageously, the applicator is solidly attached to a shaft which, itself, is attached to the closing member.

It may be a moulded comb or a moulded brush as described in documents WO 06/125122 or FR 2769529.

The closing member may be coupled to the container by screwing. Alternatively, the coupling between the closing member and the container occurs other than by screwing, in particular via a bayonet mechanism, by click-fastening or by tightening. The term “click-fastening” is understood to mean, in particular, any system that involves surmounting a rim or bead of material by elastic deformation of a portion, especially of the closing member, then by returning to the elastically unstressed position of said portion after the rim or bead has been surmounted.

The container may be at least partially made of thermoplastic material. Examples of thermoplastic materials that may be mentioned include polypropylene or polyethylene.

Alternatively, the container is made of non-thermoplastic material, especially glass or metal (or alloy).

The container is preferably equipped with a wiping element arranged in the region of the aperture of the container. Such a wiping element makes it possible to wipe the applicator and possibly the shaft to which it may be solidly attached. Such a wiping element is described, for example, in patent FR 2 792 618.

Preferably, the first composition and the second composition are packaged in separate packaging.

Each composition may be packaged separately in one and the same packaging article.

Each composition may also be packaged in a compartment within one and the same packaging article, the mixing of the two compositions taking place at the end(s) of the packaging article during the delivery of each composition.

Alternatively, each of the first and second compositions may be packaged in a different packaging article.

The following example is given by way of illustration of the present invention, and cannot limit the scope thereof.

### EXEMPLARY EMBODIMENT

Composition 1 (Vitrebond 7512L from 3M):
Itaconic acid <42%
2-Hydroxyethyl methacrylate 20-25%
Water 30-40%

Composition 2 (Vitrebond 7512P from 3M):
Diphenyliodonium chloride 1-5%
Disodium hydrogen orthophosphate 0.5-1.5%
Fluoroaluminosilicate glass powder 95-99%

Compositions 1 and 2 are sold in kit form by 3M under the reference Vitrebond 7510.

These 2 compositions are mixed and then the mixture obtained is applied to a test specimen of false eyelashes. This test specimen is then exposed to a light source (power: 800 mW/cm², wavelength: 450 to 470 nm for 30 s), while mechanically imparting a curved shape to the test specimen.

False eyelashes are thus obtained with a curvature which is remanent over time (at least 24 hours).

These 2 compositions could also have been mixed directly in situ on the test specimen of false eyelashes.

1. A method for making up eyelashes, comprising:
a) coating the eyelashes with a deposit of at least one composition comprising, in a physiologically acceptable medium, at least one compound, to obtain coated eyelashes, and
b) modifying a curvature of the eyelashes by placing a shaping tool in contact with the coated eyelashes in the presence of a stimulus to which said compound is sensitive, and maintaining contact with the coated eyelashes until a modulus of rigidity Gp of the composition is greater than or equal to 1 GPa,
wherein the modulus of rigidity of at least 1 GPa is obtained in a time t that is less than a time t₀ that would be needed to obtain it by leaving the deposit to dry at room temperature.

2. The method of claim 1, wherein the time t is at least 20% less than the time t₀.

3. The method of claim 1, wherein, once attained, the modulus of rigidity Gp of said deposit does not drop below 1 GPa when it is brought into contact with water or sebum.

4. A method for making up eyelashes, comprising:
a) coating the eyelashes with a first composition and with a second composition, in order to form a deposit on the eyelashes and obtain coated eyelashes, and
b) modifying a curvature of the eyelashes by placing a shaping tool in contact with the coated eyelashes, and
c) crosslinking the deposit by exposing the deposit to a radiation of a suitable wavelength from a light source for a sufficient time,
wherein the first composition comprises at least one photopolymerizable ionomer,
the second composition comprises at least one reactive powder,
either or both of the first and second compositions comprise water, and
the coating a) and modifying b) are simultaneous or wherein the modifying b) is subsequent to the coating a).

5. The method of claim 4, wherein the first composition comprises at least one photopolymerizable ionomer of formula (I) below:
BXₘYₙ (I)
wherein B is an oligomeric or polymeric organic backbone comprising carbon-carbon bonds,
X is a carboxyl group,
each Y independently is a substituted or unsubstituted ethylenic unsaturated group selected from the group consisting of an acrylate, a methacrylate, an alkene and an acrylamide,
m is an integer greater than or equal to 2, and
n is an integer greater than or equal to 1.

6. The method of claim 4, wherein the reactive powder is at least one selected from the group consisting of a fluoroaluminosilicate and a fluoroaluminoborate.

7. The method of claim 4, wherein the light source has a wavelength from 10 nm and to 500 μm.

8. The method of claim 4, wherein the light source has a power from 500 mW/cm² to 2400 mW/cm².

9. The method of claim 4, wherein said first and second compositions are mixed before application to the eyelashes.

10. The method of claim 4, wherein said first and second compositions are mixed in situ when applied to the eyelashes.

11. The method of claim 4,
wherein either or both of the first and second compositions comprise at least one additive selected from the group consisting of a pigment, a wax, a filler, a thickener, a surfactant, a film-forming polymer, and an oil.

12. Kit for coating keratin fibres, comprising:
a first composition comprising at least one photopolymerizable ionomer;
a second composition comprising at least one reactive powder; and
a light source,
wherein either or both of the first and second compositions comprise water, and
either or both of the first and second compositions comprise at least one additive selected from the group consisting of pigments, waxes, fillers, thickeners, surfactants, film-forming polymers, and oils.

13. The method of claim 1, wherein the time t is at least 40% less than the time t₀.

14. The method of claim 4, wherein the light source has a wavelength from 400 to 700 nm

15. The method of claim 4, wherein the light source has a wavelength from 400 to 520 nm.

16. The method of claim 4, wherein the light source has a power from 700 to 850 mW/cm².
